(19) United States
(12) Patent Application Publication
(10) Pub. No.: US 2008/0314664 A1
(43) Pub. Date: Dec. 25, 2008

(54) Energy Recovery Drive

(75) Inventors: Matthias Mueller, Neusaess (DE); Steffen Mutschler, Ulm (DE)

Correspondence Address: SCULLY SCOTT MURPHY & PRESSER, PC, 400 GARDEN CITY PLAZA, SUITE 300, GARDEN CITY, NY, 11530, US

(73) Assignee: BOSCH REXROTH AG, Stuttgart (DE)

(21) Appl. No.: 12/158,158

(22) PCT Filed: Dec. 19, 2006
(86) PCT No.: PCT/EP2006/012259

§ 371 Date: Jun. 19, 2008

(30) Foreign Application Priority Data
Dec. 20, 2005 (DE) 10 2005 060 991.0
Feb. 13, 2006 (DE) 10 2006 006 583.2

(51) Int. Cl. B60K 6/12

(52) U.S. Cl. 180/165; 180/305; 60/416

(57) ABSTRACT

The invention relates to an energy recovery drive. Said drive comprises a first driving shaft (3) and a second driving shaft (4). The second driving shaft (4) is connected to a hydrostatic piston engine (5). Said hydrostatic piston engine (5) is connected to a first accumulator (11) and a second accumulator (12) for accumulating pressure energy. The first drive shaft (3) and the second drive shaft (4) can be connected to each other via a gear train (6), said gear train (6) comprising at least one first gearwheel (7) and a second gearwheel (8) which is configured as a sliding gearwheel.

The invention relates to an energy recovery drive.

A drive with recovery of kinetic energy is known from AT 395 960 B. In the driver a hydrostatic piston engine as a pump and a hydromotor are connected in a closed circuit. Connected to each of the two working lines connecting the piston engines is an accumulator. The pump is designed to pump in one direction and is driven by a prime mover. The working line on the pumping side is connected to a high-pressure accumulator.

During driving operation, the hydromotor, which can be swivelled starting out from a neutral position in two directions, is deflected in a first direction and thus operated as a hydrometer by the pressure produced by the hydropump in the working line on the pumping side. Once a desired driving speed is reached, the deflection is cancelled and preferably reduced to zero, so that the vehicle rolls freely. To brake the vehicle, the hydrometer is deflected in the opposite direction, so that it now conveys pressure medium for its part into the working line on the pumping side. The pressure medium pumped into the working line on the pumping side is stored in the high-pressure accumulator with an increase in the pressure. In order subsequently to extract the pressure energy stored there, the hydrometer is swivelled once more in its original direction and the pressure medium stored under high pressure in the high-pressure accumulator is expanded via the hydrometer driving the vehicle in the direction of the low-pressure accumulator. The low-pressure accumulator ensures equalization of the volume flow.

In the drive described, it is disadvantageous that regardless of the respective driving situation, the accumulator device for storing and recovering the kinetic energy is connected to the hydrostatic drive. Furthermore, such an arrangement, in which the accumulators are connected to the working lines, can only be used in connection with a hydrostatic gearbox. The accumulators are connected permanently to the working circuit. In contrast, decoupling and thus a distinction between a working operation or a transport journey, for example, are not possible. The permanent connection of the high-pressure accumulator also causes undesirable compressibility in the area of pressurization of the hydromotor.

The object of the invention is to create a drive with a simple and inexpensive option for connecting a system for energy recovery.

The object is achieved by the energy recovery drive according to the invention with the features of claim 1.

According to claim 1, the drive has a first drive shaft of a drive train and a second drive shaft. The second drive shaft is connected to a hydrostatic piston engine. The drive also comprises at least one accumulator for storing pressure energy. The first drive shaft and the second drive shaft are connectable to one another via a gear stage, which comprises at least one first and one second gearwheel. In this case the second gearwheel is formed as a sliding gearwheel.

The drive according to the invention makes it possible to connect the first and the second drive shaft to one another only when required by means of the gearwheel formed as a sliding gearwheel. Thus the connection of components required for energy recovery can remain restricted to operating situations in which a recovery of kinetic energy offers advantages. When used on a construction site vehicle, for example, this is the working operation on the construction site. A transport journey, on the other hand, can take place by moving the sliding gearwheel by means of a traction drive, which works independently of energy recovery.

Due to the connection of the energy recovery by means of a shiftable gear stage, the traction drive itself can be formed in any manner. The energy recovery, in contrast, is executed by an additional hydrostatic piston engine, wherein churning and following losses are avoided due to possible disconnection. The simple execution of the switching option by means of a sliding gearwheel in the gear stage has the advantage, furthermore, that complex clutch mechanics are not necessary. Only an actuation facility for the axial displacement of the sliding gearwheel is necessary. Although connection or disconnection of the energy recovery is thus only possible when the vehicle is stationary or when the drive shafts are stopped, such a stoppage is easy to bring about when changing to the working operation on a construction site. The sliding gearwheel can then be uncoupled again when a transport journey is to be made again at the end of a working session. In contrast to a solution with clutch, the proposed solution with a sliding gearwheel is sturdy and not very susceptible to wear.

Advantageous developments of the drive according to the invention are elaborated in the sub-claims.

Thus it is particularly advantageous that the gearwheel executed as a sliding gearwheel is arranged movably on the second drive shaft. Thus the gearwheel, which due to its formation as a sliding gearwheel is not fixedly connected to the drive shaft, is not also rotated by the traction drive during a transport journey. The first gearwheel, in contrast, can be connected fixedly to the first drive shaft, due to which a reduction in wear occurs in turn.

To improve shifting convenience, it is advantageous, furthermore, to provide axial gearing on the first gearwheel and the second gearwheel respectively. With the aid of the axial gearing, the engagement of the gearwheels executed as spur gears is improved. One consequence of this is a reduction in the shift jolt when connecting the energy recovery system.

Even during construction site operation it can be necessary to prevent extensive pumping of pressure medium by the hydrostatic piston engine into a high-pressure accumulator. Since it is provided in construction site operation that the two gearwheels remain in engagement, it is advantageous to execute the hydrostatic piston engine as an adjustable piston engine. This makes it possible to adjust the hydrostatic piston engine to a zero delivery volume in a situation in which a further take-up of pressure medium in the high-pressure accumulator is not possible. Further pumping of pressure medium is suppressed and the stored kinetic energy can be retrieved at any time. To this end the hydrostatic piston engine is also connected via the first and the second gearwheel of the gear stage to the first drive shaft. To extract pressure medium, it is therefore sufficient to adjust the delivery volume of the hydrostatic piston engine back to an absorption volume corresponding to the energy to be extracted.

It is also advantageous to let the hydrostatic piston engine convey pressure medium between a first accumulator and a second accumulator. The arrangement of the piston engine between a first accumulator and a second accumulator has the advantage that even on the low-pressure side of the hydrostatic piston engine a certain admission pressure is generated by the second accumulator. The admission pressure in the closed system prevents cavitation from arising on the suction side of the hydrostatic piston engine.

According to a further advantageous embodiment, the first drive shaft connects a drive engine to a gearbox of the vehicle drive. In this case the drive shaft can be formed by the power take-off shaft of the drive engine itself or be executed as part of a connecting shaft between drive engine and gearbox. The first gearwheel is preferably connected fixedly to the first drive shaft. Due to the coupling of the energy recovery system to a drive shaft connected to the drive engine, relatively high speeds of the drive shaft are available for driving the hydrostatic piston engine. Matching of the high output speeds of the drive engine to the ideal speed range for the hydrostatic piston engine is achieved in this case by the gear stage.

According to a further preferred embodiment, the drive shaft is a gear output shaft of a gearbox of the drive. The arrangement on the gear output side has the advantage in contrast that the masses rotating at high speeds are kept low.

An embodiment of the drive according to the invention is shown in the drawing and is explained in greater detail in the following description.

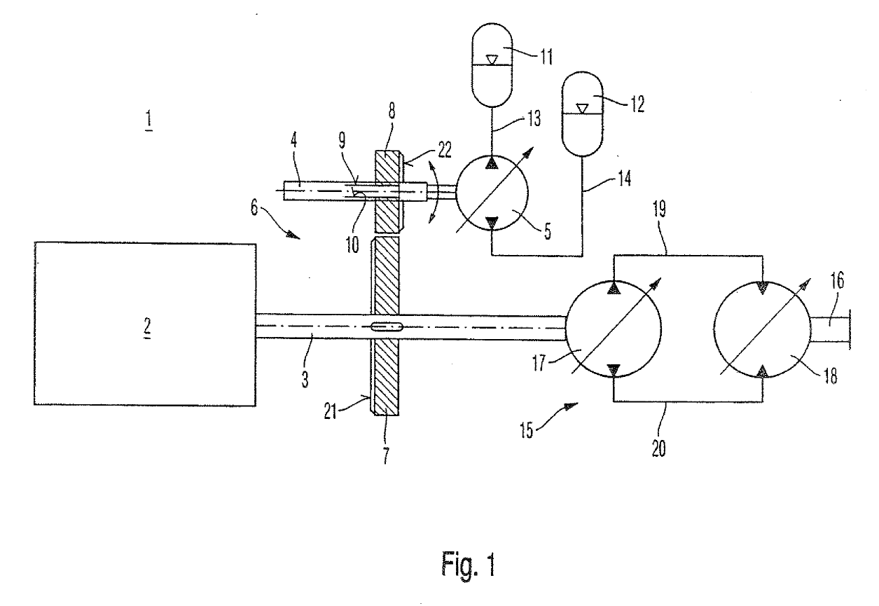

FIG. 1 shows an embodiment of an energy recovery drive according to the invention.

In FIG. 1, an energy recovery drive 1 according to the invention is shown schematically. The drive 1 comprises a drive engine 2 as a primary power source. The drive engine 2 is connected to a first drive shaft 3. The first drive shaft 3 can be the power take-off shaft of the drive engine 2 or an intermediate shaft connected thereto. The drive 1 according to the invention has an energy recovery system with a second drive shaft 4. The second drive shaft 4 is connected to a hydrostatic piston engine 5.

The hydrostatic piston engine 5 is designed to convey pressure medium in two directions and its delivery volume is preferably adjustable. To drive the hydrostatic piston engine 5, the first drive shaft 3 and the second drive shaft 4 can be coupled to one another. The coupling is carried out via a gear stage 6. The gear stage 6 comprises a first gearwheel 7 and a second gearwheel 8. The second gearwheel 8 is executed as a sliding gearwheel.

The sliding gearwheel 8 is arranged axially displaceably on gearing 9 of the second drive shaft 4. To this end the gearing 9 is executed on the second drive shaft 4 and interacts with an internal gearing 10 of the second gearwheel 8. Thus the second gearwheel 8 is arranged displaceably longitudinally on the second drive shaft 4 and is coupled fixedly to this.

The first gearwheel 7 and the second gearwheel 8 are executed as spur gears. The spacings of the first drive shaft 3 and the second drive shaft 4 permit engagement of the gearing of the first gearwheel 7 and of the second gearwheel 8. A torque can therefore be supplied by the first drive shaft 3 via the second drive shaft 4 to the hydrostatic piston engine 5. To uncouple the energy recovery system, consisting of the hydrostatic piston engine 5 as well as a first accumulator 11 and a second accumulator 12, the second gearwheel 8 is displaceable on the second drive shaft 4. In FIG. 1, the second gearwheel 8 is moved left in the gearing 9 to disconnect it until the gearing on the face of the second gearwheel 8 is no longer in engagement with the gearing on the face of the first gearwheel 7.

The energy recovery system with the first accumulator 11 and the second accumulator 12 forms a hydraulic cradle together with the hydrostatic piston engine 5 as well as the first accumulator line 13 and the second accumulator line 14. Pressure medium can be sucked by the hydrostatic piston engine 5 from the second accumulator 12 executed as a low-pressure accumulator via the second accumulator line 14 and conveyed to the first accumulator 11 with an increase in the pressure prevailing in this. The first accumulator 11 is designed as a high-pressure accumulator and connected via the first accumulator line 13 to the hydrostatic piston engine 5.

To enable the hydrostatic piston engine 5 to operate in its optimum efficiency range, the gear ratio of the gear stage 6 is matched to the optimum speed 5 and the speed of the first drive shaft 3.

The drive 1 according to the invention is executed in the embodiment shown as a traction drive. The traction drive comprises a hydrostatic gearbox 15. The hydrostatic gearbox 15 is driven by the first drive shaft 3 as a gear input shaft. A gear output shaft 16 is provided on the output side for routing the torque available to a driven vehicle axle. The hydrostatic gearbox 15 also has a hydropump 17 as well as a hydromotor 18. Both the hydropump 17 and the hydromotor 18 are preferably executed as adjustable piston engines. The hydropump 17 and the hydromotor 18 are connected to one another in a closed circuit via a first working line 19 and a second working line 20. The first drive shaft 3, the hydrostatic gearbox 15 and the gear intake shaft 16 form at least a section of a drive train of a vehicle. Other gearbox variants can also be used instead of the hydrostatic gearbox 15.

To reduce a shift jolt, which occurs on displacement of the second gearwheel 8 in the direction of the plane of rotation of the first gearwheel 7 during engagement of the gearing on the face of the two gearwheels 7 and 8, axial gearing 21, 22 is arranged on the first gearwheel 7 and the second gearwheel 8 respectively. Due to the axial gearing 21, 22, an entrainment effect of the second gearwheel 8 is produced, which like synchronization ensures speed adjustment of the second gearwheel 8 to the speed of the first gearwheel 7. As a result of this, the angular difference between the first gearwheel 7 and the second gearwheel 8 during the engagement of the gearings on the face of the two gearwheels is equalized. The axial gearings 21, 22 are arranged on the surfaces of the first and the second gearwheel 7, 8 to be oriented to one another in the uncoupled state.

During a normal driving operation, the driving speed of the vehicle driven by the drive 1 is determined exclusively by the drive train with the drive engine 2, the first drive shaft 3 and the hydrostatic gearbox 15 and gear output shaft 16. The second gearwheel 8, executed as a sliding gearwheel, is located in its lefthand position, in which the connection between the first drive shaft 3 and the second drive shaft 4 is interrupted. During such a driving operation, which can be provided e.g. for transport journeys, the energy recovery system is thus separated from the drive train. In order to be able to use the energy storage and recovery during construction site operation, the second gearwheel 8 is displaced in the gearing 9 of the second drive shaft 4 during stoppage of the vehicle until the second gearwheel 8 and the first gearwheel 7 are located in the position shown in FIG. 1 and thus the gearings of the spur gears engage in one another. The first drive shaft 3 is thus coupled to the second drive shaft 4 and the hydrostatic piston engine 5 is driven according to the speed of the first drive shaft 3. During a braking process, the hydrostatic piston engine 5 is operated as a pump and pumps pressure medium in the manner already described from the second accumulator 12 to the first accumulator 11. By adjusting the delivery or absorption volume of the hydrostatic piston engine 5 to a so-called zero stroke, it is possible to prevent further pressure medium from being pumped into the first accumulator 11 without moving the second gearwheel 8 on the gearing 9. In addition, the braking power can be changed continuously by adjusting the delivery volume.

When the braking process has been completed, the kinetic energy of the braked vehicle is stored in the first accumulator 11 as pressure energy. This pressure energy can then be reused by operating the hydrostatic piston engine 5 as a hydromotor. The pressure medium stored under high pressure in the first accumulator 11 is then expanded via the first accumulator line 13 and the hydrostatic piston engine 5. The hydrostatic piston engine 5 is driven in this case and transmits a torque to the second drive shaft 4. This output torque of the hydrostatic piston engine 5 is transferred via the gear stage 6 to the first drive shaft 3 and thus supplied to the hydrostatic gearbox 15. According to the selected gear ratio of the hydrostatic gearbox 15, a drive torque thus acts on the gear output shaft 16 due to the pressure energy stored in the first accumulator 11.

A preferred embodiment is shown in FIG. 1, in which embodiment a coupling is achieved via the first drive shaft 3, which in the embodiment shown represents a connecting shaft between the drive engine 2 and the hydrostatic gearbox 15. The first drive shaft 3 can be a gear input shaft of the hydrostatic gearbox 15, for example. Alternatively, however, it is also possible to connect the first gearwheel 7 to the gear output shaft 16 as the first drive shaft 3. Due to this, the speeds at which the first gearwheel 7 is driven are markedly reduced. An increase in the speed for driving the hydrostatic piston engine 5 can be set by the choice of the gear ratio of the gear stage.

The axial gearings 21, 22 of the first and second gearwheel 7, 8 are realized according to a simple execution by rings screwed to the gearwheels 7, 8. In a more complex execution, a synchronization device can also be provided. The displacement of the second gearwheel 8 is carried out in a manner not shown with the aid of a shift fork, which causes an axial displacement movement of the second gearwheel 8 via an actuating device, which is likewise not shown.

The invention is not limited to the embodiments shown. On the contrary, deviations from individual features of the embodiment shown are also possible without deviating from the basic idea of the invention.

1. Energy recovery drive comprising a first drive shaft of a drive train and a hydrostatic piston engine connected to a second drive shaft and at least one accumulator connected to the hydrostatic piston engine for storing pressure energy, wherein the first drive shaft and the second drive shaft are connectable to one another via a gear stage, which gear stage comprises at least a first gearwheel and a second gearwheel executed as a sliding gearwheel.

2. Drive according to claim 1, wherein
the second gearwheel executed as a sliding gearwheel is arranged displaceably on the second drive shaft.

3. Drive according to claim 1, wherein
the first gearwheel and the second gearwheel are spur gears and each have axial gearing.

4. Drive according to claim 1, wherein
the delivery/absorption volume of the hydrostatic piston engine is adjustable.

5. Drive according to claim 1, wherein
the hydrostatic piston engine is connected to a first accumulator and a second accumulator.

6. Drive according to claim 1, wherein
the first drive shaft connects a drive engine to a gearbox.

7. Drive according to claim 1, wherein
the first drive shaft is a gear output shaft of a gearbox of the drive.
